(19) United States
(12) Patent Application Publication
(10) Pub. No.: US 2026/0370066 A1
(43) Pub. Date: Nov. 19, 2026

(54) CORE FOR ROTATING ELECTRIC MACHINE, ARMATURE AND ROTATING ELECTRIC MACHINE

(71) Applicant: DENSO CORPORATION, Kariya-city (JP)

(72) Inventors: Yusuke TATEISHI, Kariya-city (JP); Yuji HAYASHI, Kariya-city (JP)

(73) Assignee: DENSO CORPORATION, Kariya-city (JP)

(21) Appl. No.: 19/733,097

(22) Filed: Jul. 7, 2026

Related U.S. Application Data
(63) Continuation of application No. PCT/JP2024/042553, filed on Dec. 2, 2024.

(30) Foreign Application Priority Data
Feb. 15, 2024 (JP) 2024-021462

(51) Int. Cl. H02K 1/16; H02K 15/0275; H02K 21/24

(52) U.S. Cl. CPC H02K 1/16; H02K 15/0275; H02K 21/24

(57) ABSTRACT

A stator core is formed of magnetic powder. The magnetic powder has iron powder formed of an iron-based material, and covering portions having higher electrical insulation properties than the iron powder and covering the iron powder. Moreover, the magnetic powder includes a plurality of types of magnetic powders differing in at least one of thickness and material of the covering portions. A stator includes the stator core. A motor includes the stator.

### CROSS-REFERENCE TO RELATED APPLICATIONS

The present application is a continuation application of International Application No. PCT/JP2024/042553 filed on Dec. 2, 2024, which is based on and claims priority from Japanese Patent Application No. 2024-021462 filed on Feb. 15, 2024. The entire contents of these applications are incorporated by reference into the present application.

### BACKGROUND

### 1 Technical Field

The present disclosure relates to cores for rotating electric machines, armatures and rotating electric machines.

### 2 Description of Related Art

There is disclosed, for example in Japanese Unexamined Patent Application Publication No. JP 2008016670 A, a stator core formed using a powder magnetic core obtained by compression-molding soft-magnetic powder that is an aggregate of a plurality of soft-magnetic particles. In the stator core described in this patent document, the average particle diameter of those soft-magnetic particles which are located in a second part of the stator core is greater than the average particle diameter of those soft-magnetic particles which are located in a first part of the stator core. Consequently, it becomes possible to make the magnetic permeability of the first part of the stator core and the magnetic permeability of the second part of the stator core different from each other.

### SUMMARY

The configuration described in the aforementioned patent document is a useful configuration in terms of enabling adjustment of the magnetic permeability of each part of a core (e.g., a stator core) for a rotating electric machine. However, the configuration described in the aforementioned patent document fails to take into consideration adjustment of the electrical insulation properties of each part of a core for a rotating electric machine.

The present disclosure has been accomplished in view of the above circumstances.

According to a first aspect of the present disclosure, there is provided a core for a rotating electric machine. The core is formed of magnetic powder having: a powdery base material constituted of an iron-based material; and covering portions having higher electrical insulation properties than the base material and covering the base material. Moreover, the magnetic powder includes a plurality of types of magnetic powders differing in at least one of thickness and material of the covering portions. According to a second aspect of the present disclosure, there is provided an armature which includes: a core formed of magnetic powder, the magnetic powder having a powdery base material constituted of an iron-based material and covering portions having higher electrical insulation properties than the base material and covering the base material, wherein the magnetic powder comprises a plurality of types of magnetic powders differing in at least one of thickness and material of the covering portions; and a coil arranged along the core and configured to generate a magnetic field when supplied with electric power. According to a third aspect of the present disclosure, there is provided a rotating electric machine which includes a stator and a rotor. One of the stator and the rotor includes an armature that includes: a core formed of magnetic powder, the magnetic powder having a powdery base material constituted of an iron-based material and covering portions having higher electrical insulation properties than the base material and covering the base material, wherein the magnetic powder comprises a plurality of types of magnetic powders differing in at least one of thickness and material of the covering portions; and a coil arranged along the core and configured to generate a magnetic field when supplied with electric power. The other of the stator and the rotor has a magnet arranged so as to face the coil and the core.

With the above configuration, it becomes possible to appropriately adjust the electrical insulation properties of each part of the core for the rotating electric machine.

### BRIEF DESCRIPTION OF THE DRAWINGS

FIG. 1 is a perspective view showing a radial-gap toothless motor, with part of the motor cut away.

FIG. 2 is an exploded perspective view showing the radial-gap toothless motor in a disassembled state, with parts of some components thereof cut away.

FIG. 3 is a perspective view showing an axial-gap toothless motor, with part of the motor cut away.

FIG. 4 is an exploded perspective view showing the axial-gap toothless motor in a disassembled state, with parts of some components thereof cut away.

FIG. 5 is a perspective view showing an axial-gap toothed motor, with part of the motor cut away.

FIG. 6 is an exploded perspective view showing the axial-gap toothed motor in a disassembled state, with parts of some components thereof cut away.

FIG. 7 is a diagram schematically showing a powder magnetic core constituting a stator core according to a first embodiment.

FIG. 8 is a diagram schematically illustrating a manufacturing process of the stator core according to the first embodiment.

FIG. 9 is a diagram schematically showing magnetic powder after completion of a first coating step.

FIG. 10 is a diagram schematically showing the magnetic powder after completion of a second coating step.

FIG. 11 is a diagram schematically showing the magnetic powder after completion of a third coating step.

FIG. 12 is a diagram schematically showing a first-type magnetic powder.

FIG. 13 is a diagram schematically showing a second-type magnetic powder.

FIG. 14 is a diagram schematically showing magnetic powder manufactured by crushing a stator core.

FIG. 15 is a perspective view showing a coil assembly and a stator core according to a second embodiment.

FIG. 16 is a plan view, as viewed in the direction of an arrow S1 shown in FIG. 15, schematically showing the stator core according to the second embodiment with the coil assembly mounted thereto.

FIG. 17 is a side cross-sectional view, as viewed in the direction of an arrow S2 shown in FIG. 15, schematically showing the stator core according to the second embodiment with the coil assembly mounted thereto.

FIG. 18 is an enlarged side cross-sectional view schematically showing the stator core according to the second embodiment with the coil assembly mounted thereto, wherein the region encircled by a line S3 in FIG. 17 is shown in a magnified manner.

FIG. 19 is a perspective view showing a coil assembly, magnets and a stator core according to a third embodiment.

FIG. 20 is a side cross-sectional view, as viewed in the direction of an arrow S4 shown in FIG. 19, schematically showing the stator core according to the third embodiment.

FIG. 21 is an enlarged side cross-sectional view schematically showing the stator core according to the third embodiment, wherein the region encircled by a line S5 in FIG. 20 is shown in a magnified manner.

FIG. 22 is a schematic diagram for explaining a manufacturing process of the stator core according to the second embodiment, which illustrates a step of placing the first-type magnetic powder into a first mold.

FIG. 23 is another schematic diagram for explaining the manufacturing process of the stator core according to the second embodiment, which illustrates a step of compressing the first-type magnetic powder placed into the first mold.

FIG. 24 is another schematic diagram for explaining the manufacturing process of the stator core according to the second embodiment, which shows a state where the molding of that part of the stator core according to the second embodiment which is formed of the first-type magnetic powder has been completed.

FIG. 25 is another schematic diagram for explaining the manufacturing process of the stator core according to the second embodiment, which illustrates a step of injecting the second-type magnetic powder into a fourth mold.

FIG. 26 is a diagram schematically showing a molded product into which a part of the stator core according to the second embodiment which is formed of the first-type magnetic powder and parts of the stator core which are formed of the second-type magnetic powder are integrated.

FIG. 27 is a schematic diagram for explaining a manufacturing process of the stator core according to the third embodiment, which illustrates a step of placing the second-type magnetic powder into a first mold.

FIG. 28 is another schematic diagram for explaining the manufacturing process of the stator core according to the third embodiment, which illustrates a step of compressing the second-type magnetic powder placed into the first mold.

FIG. 29 is another schematic diagram for explaining the manufacturing process of the stator core according to the third embodiment, which illustrates a step of placing the first-type magnetic powder into the first mold.

FIG. 30 is another schematic diagram for explaining the manufacturing process of the stator core according to the third embodiment, which illustrates a step of compressing the first-type magnetic powder placed into the first mold together with the second-type magnetic powder.

FIG. 31 is a diagram schematically showing a molded product into which that part of the stator core according to the third embodiment which is formed of the first-type magnetic powder and that part of the stator core which is formed of the second-type magnetic powder are integrated.

FIG. 32 is a perspective view of a stator core according to a fourth embodiment as viewed from a second side in an axial direction.

FIG. 33 is a schematic diagram for explaining a magnetic-permeability inspection method.

FIG. 34 is a schematic diagram for explaining an electrical-resistivity inspection method.

FIG. 35 is a schematic diagram for explaining a hardness inspection method.

FIG. 36 is a perspective view of a stator core according to a fifth embodiment as viewed from a first side in the axial direction.

FIG. 37 is a perspective view of a stator core according to a sixth embodiment as viewed from the second side in the axial direction.

FIG. 38 is a schematic diagram for explaining a process of forming a stator core main body and an inspection part, which illustrates a step of placing the first-type magnetic powder into a first mold.

FIG. 39 is another schematic diagram for explaining the process of forming the stator core main body and the inspection part, which illustrates a step of compressing the first-type magnetic powder placed into the first mold.

FIG. 40 is another schematic diagram for explaining the process of forming the stator core main body and the inspection part, which illustrates a step of placing the second-type magnetic powder into a third mold.

FIG. 41 is another schematic diagram for explaining the process of forming the stator core main body and the inspection part, which illustrates a step of compressing the second-type magnetic powder placed into the third mold.

FIG. 42 is a diagram schematically showing the stator core main body and the inspection part.

### DESCRIPTION OF EMBODIMENTS

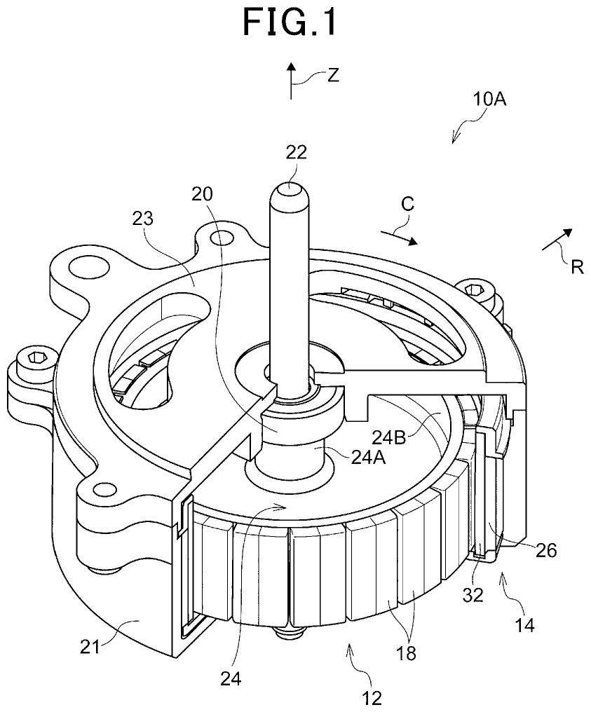

With reference to FIGS. 1 to 6, explanation will be given of the configurations of three types of motors 10A, 10B and 10C to which the structure of a core for a rotating electric machine according to the present disclosure is applied. It should be noted that the arrows Z, R and C suitably shown in the drawings respectively indicate a first side in a rotation axial direction, the outer side in a rotation radial direction and a first side in a rotation circumferential direction of a rotor 12 that will be described later. Moreover, in the case of merely indicating the axial direction, the radial direction and the circumferential direction, unless specified otherwise, the arrows Z, R and C respectively indicate the rotation axial direction, the rotation radial direction and the rotation circumferential direction of the rotor 12. In addition, the three types of motors 10A, 10B and 10C are examples of rotating electric machines.

### First-Type Motor 10A

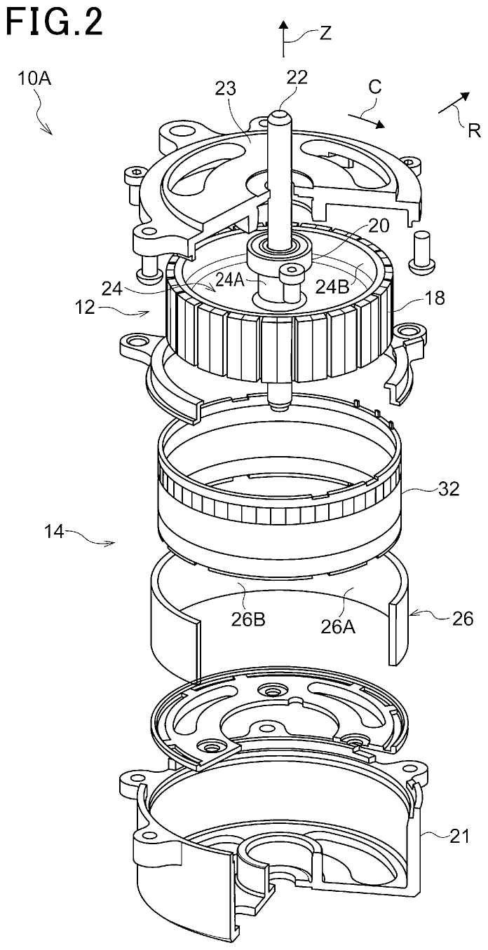

As shown in FIGS. 1 and 2, the first-type motor 10A is a radial-gap brushless motor in which the rotor 12 is arranged radially inside a stator 14 that serves as an armature.

The rotor 12 includes a rotating shaft 22 that is rotatably supported by a pair of bearings 20, a rotor core 24 fixed to the rotating shaft 22, and a plurality of magnets 18 fixed to a radially outer surface of the rotor core 24. The pair of bearings 20 are supported respectively by a frame 21 and a frame end 23. The stator 14 and other components are accommodated between the frame 21 and the frame end 23.

The rotor core 24 has a first cylindrical part 24A to which the rotating shaft 22 is fixed by press fitting or the like, and a second cylindrical part 24B arranged radially outside the first cylindrical part 24A. The second cylindrical part 24B has an outer circumferential surface, which constitutes the radially outer surface of the rotor core 24, formed along the circumferential direction into a cylindrical surface. The magnets 18, which will be described later, are fixed to the outer circumferential surface of the second cylindrical part 24B.

The magnets 18 are formed of a magnetic compound whose intrinsic coercive force Hc is higher than or equal to 400 [kA/m] and whose residual flux density Br is higher than or equal to 1.0 [T]. For example, the magnets 18 may be formed of a magnetic compound such as NdFe₁₁TiN, Nd₂Fe₁₄B, Sm₂Fe₁₇N₃ or FeNi. Moreover, as mentioned above, the magnets 18 are fixed to the outer circumferential surface of the second cylindrical part 24B of the rotor core 24. Furthermore, those magnets 18 each of which has a radially outer surface forming an N pole and those magnets 18 each of which has a radially outer surface forming an S pole are arranged alternately in the circumferential direction.

The stator 14 includes an annular stator core 26, which is a core for a rotating electric machine according to the present disclosure, and a coil assembly 32 mounted to the stator core 26. In addition, the stator 14 has a toothless structure such that no part of the stator core 26 is arranged between coils each constituting a part of the coil assembly 32.

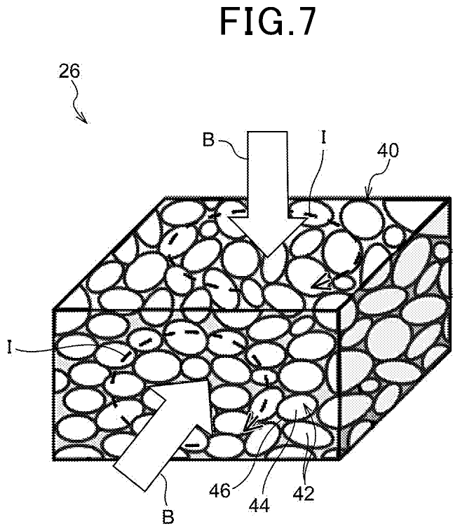

The stator core 26 is formed of magnetic powder 42, which will be described later with reference to FIG. 7, into a cylindrical shape. The stator core 26 is arranged coaxially with the rotor 12; and the axial center position of the stator core 26 coincides in the axial direction with the axial center positions of the magnets 18 fixed to the rotor core 24. In addition, a radially inner surface of the stator core 26 serves as a coil-facing surface 26A that is arranged so as to radially face the coils of the coil assembly 32, and also serves as a magnet-facing surface 26B that is arranged so as to radially face the magnets 18 of the rotor 12.

### Second-type Motor 10B

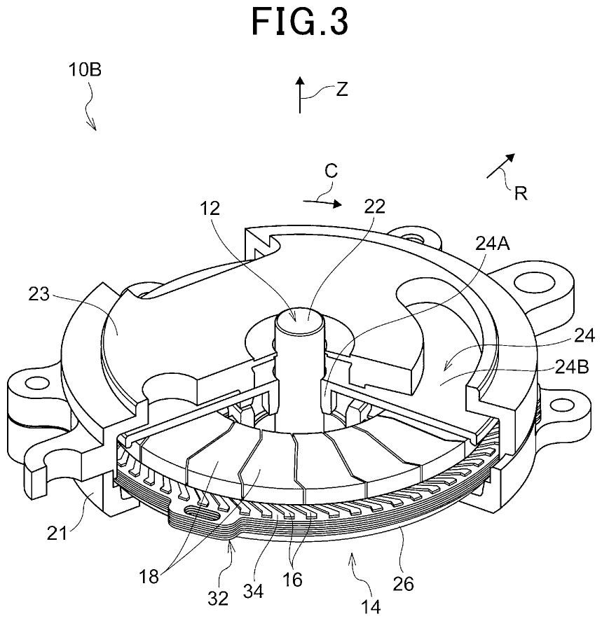

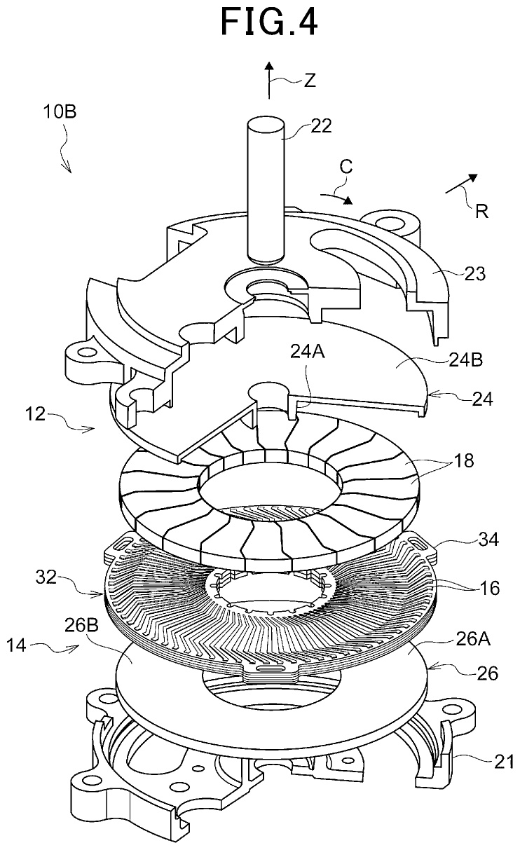

As shown in FIGS. 3 and 4, the motor 10B is an axial-gap brushless motor in which the rotor 12 and the stator 14 are arranged so as to face each other in the axial direction; the stator 14 serves as an armature.

The rotor 12 includes a rotating shaft 22 that is rotatably supported by a pair of bearings (not shown), a rotor core 24 fixed to the rotating shaft 22, and a plurality of magnets 18 fixed to a surface of the rotor core 24 on the second side in the axial direction. In addition, the pair of bearings are supported respectively by a frame 21 and a frame end 23. The stator 14 and other components are accommodated between the frame 21 and the frame end 23.

The rotor core 24 has a first cylindrical part 24A to which the rotating shaft 22 is fixed by press fitting or the like, and a discoid part 24B extending radially outward from an end portion of the first cylindrical part 24A on the first side in the axial direction. The discoid part 24B is formed in a discoid shape whose thickness direction coincides with the axial direction. The magnets 18, which will be described later, are fixed to a surface of the discoid part 24B on the second side in the axial direction.

The magnets 18 are formed of the same magnetic compound as those of the motor 10A described above. Moreover, the magnets 18 are fixed to the surface of the discoid part 24B of the rotor core 24 on the second side in the axial direction. Furthermore, those magnets 18 each of which has a second-axial-side surface forming an N pole and those magnets 18 each of which has a second-axial-side surface forming an S pole are arranged alternately in the circumferential direction.

The stator 14 includes a stator core 26 formed in a discoid shape whose thickness direction coincides with the axial direction, and a coil assembly 32 arranged along a surface of the stator core 26 on the first side in the axial direction; the stator core 26 is a core for a rotating electric machine according to the present disclosure. In addition, the stator 14 has a toothless structure such that no part of the stator core 26 is arranged between coils 16 each constituting a part of the coil assembly 32.

The stator core 26 is formed of the magnetic powder 42 which will be described later with reference to FIG. 7. The stator core 26 is formed in a plate shape whose thickness direction coincides with the axial direction, and has an annular shape as viewed in the axial direction. The stator core 26 is arranged coaxially with the rotor 12; and the radial center position of the stator core 26 coincides in the radial direction with the radial center positions of the magnets 18 fixed to the rotor core 24. In addition, the surface of the stator core 26 on the first side in the axial direction serves as a coil-facing surface 26A that is arranged so as to axially face the coils 16 of the coil assembly 32, and also serves as a magnet-facing surface 26B that is arranged so as to axially face the magnets 18 of the rotor 12.

The coil assembly 32 includes an annular base plate 34 formed of an electrically insulative material, and the coils 16 formed on the base plate 34.

### Third-Type Motor 10C

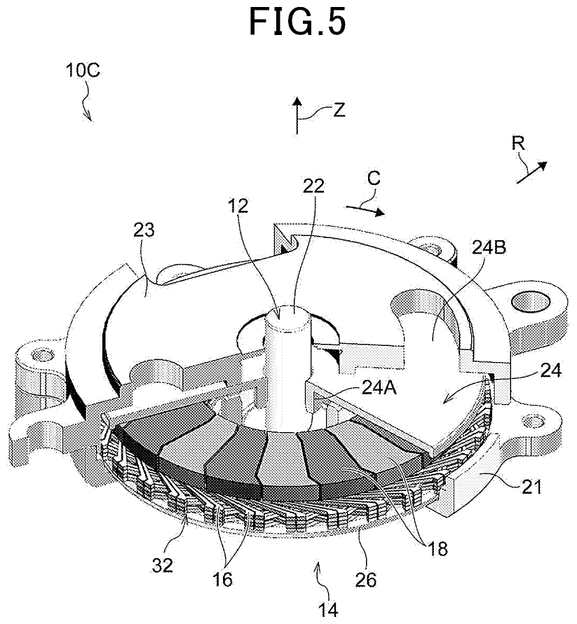

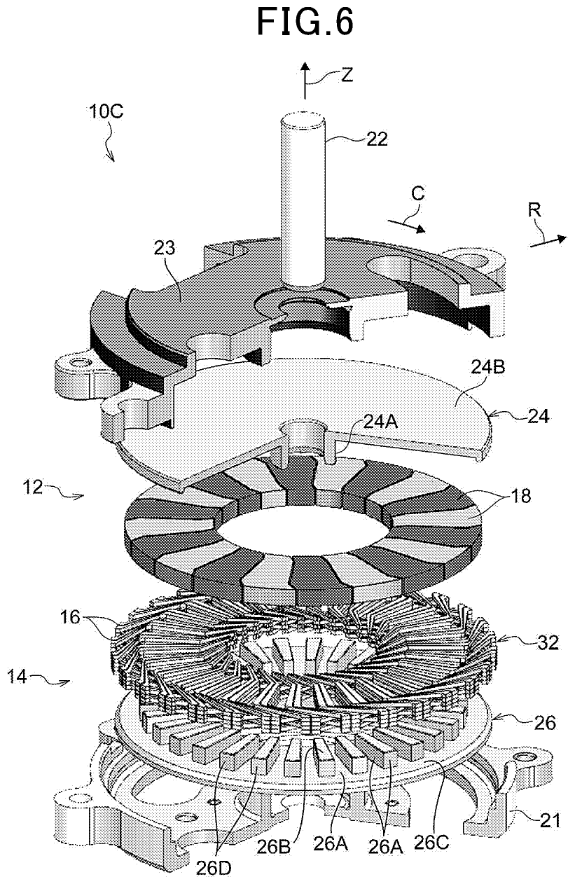

As shown in FIGS. 5 and 6, the configuration of the motor 10C is identical to the configuration of the motor 10B described above except for points to be described later. Therefore, members and parts of the motor 10C corresponding to those of the motor 10B are designated by the same reference signs as the corresponding members and parts of the motor 10B; and description of these parts and members will be omitted hereinafter.

As shown in FIGS. 5 and 6, the stator core 26 of the motor 10C has a base plate part 26C formed in a discoid shape whose thickness direction coincides with the axial direction, and tooth parts 26D protruding from the base plate part 26C toward the first side in the axial direction and arranged at equal intervals in the circumferential direction. A surface of the base plate part 26C on the first side in the axial direction serves as a coil-facing surface 26A that is arranged so as to axially face the coils 16 of the coil assembly 32. Moreover, end surfaces of the tooth parts 26D on the first side in the axial direction serve as magnet-facing surfaces 26B that are arranged so as to axially face the magnets 18 of the rotor 12. Furthermore, both circumferential end surfaces and both radial end surfaces of each of the tooth parts 26D serve as coil-facing surfaces 26A that are arranged so as to face the coils 16 of the coil assembly 32.

The coil assembly 32 of the motor 10C has a configuration obtained by adding, to the configuration of the coil assembly 32 of the motor 10B described above, holes through which the tooth parts 26D of the stator core 26 are inserted. The tooth parts 26D of the stator core 26 are located respectively in gaps between the coils 16 of the coil assembly 32.

### First Embodiment

Next, the configuration of a stator core 26 according to a first embodiment will be described in detail. It should be noted that the configuration of the stator core 26 according to the first embodiment can be applied to the stator cores 26 of the above-described motors 10A, 10B and 10C and to stator cores 26 of other motors.

FIG. 7 schematically shows a powder magnetic core 40 that constitutes the stator core 26 according to the first embodiment. The powder magnetic core 40 is formed by molding magnetic powder 42 into a predetermined shape and dimensions. The magnetic powder 42 includes iron powder 44, which is a base material, and covering portions 46 that cover the iron powder 44. The iron powder 44 is powder of iron pulverized so as to have a particle diameter within a predetermined range. The covering portions 46 are coating films formed of an inorganic material having higher electrical insulation properties than the iron powder 44 that is the base material. The covering portions 46 are formed by applying a coating material for forming the coating films to the magnetic powder 42. Examples of the material forming the covering portions 46 include phosphate-based materials, SiO2-based (i.e., silicon dioxide-based) materials, Al2O3-based (i.e., alumina-based) materials, MgO-based (i.e., magnesium oxide-based) materials and ferrite-based materials. In addition, the aforementioned materials may be used in combination.

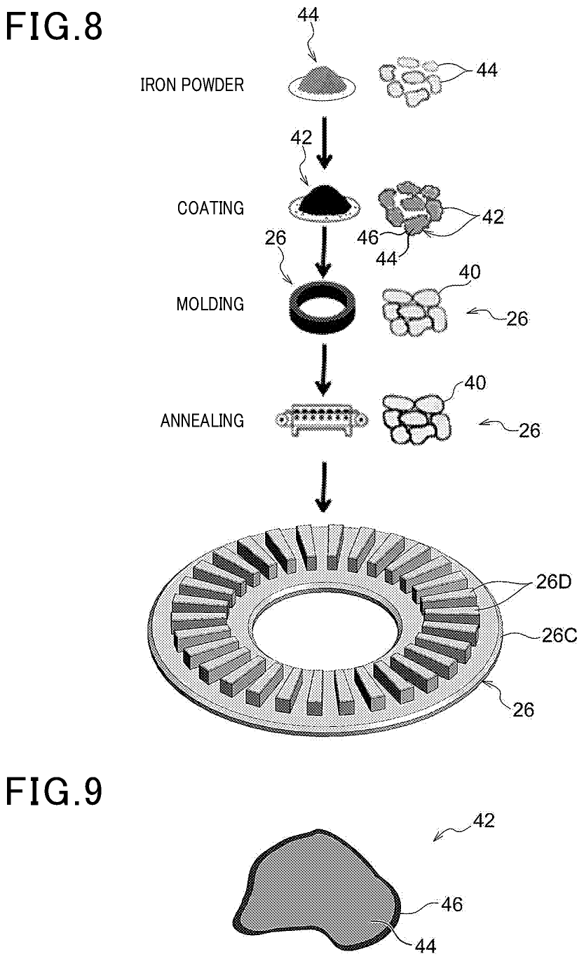

FIG. 8 schematically illustrates a manufacturing process of the stator core 26 according to the first embodiment. To manufacture the stator core 26, first, the coating material for forming the covering portions 46 is applied to the iron powder 44. Consequently, the iron powder 44 is covered by the covering portions 46, thereby forming the magnetic powder 42. Then, a predetermined amount of the magnetic powder 42 is placed into a mold and pressed (i.e., compressed), thereby molding the magnetic powder 42 placed into the mold into a predetermined shape and dimensions. For example, the magnetic powder 42 placed into the mold may be molded into the shape and dimensions of any of the stator cores 26 of the above-described motors 10A, 10B and 10C. Next, the magnetic powder 42 molded into the predetermined shape and dimensions is heated. In the present embodiment, as a heat treatment, annealing is performed. Through the above steps, the stator core 26 is obtained.

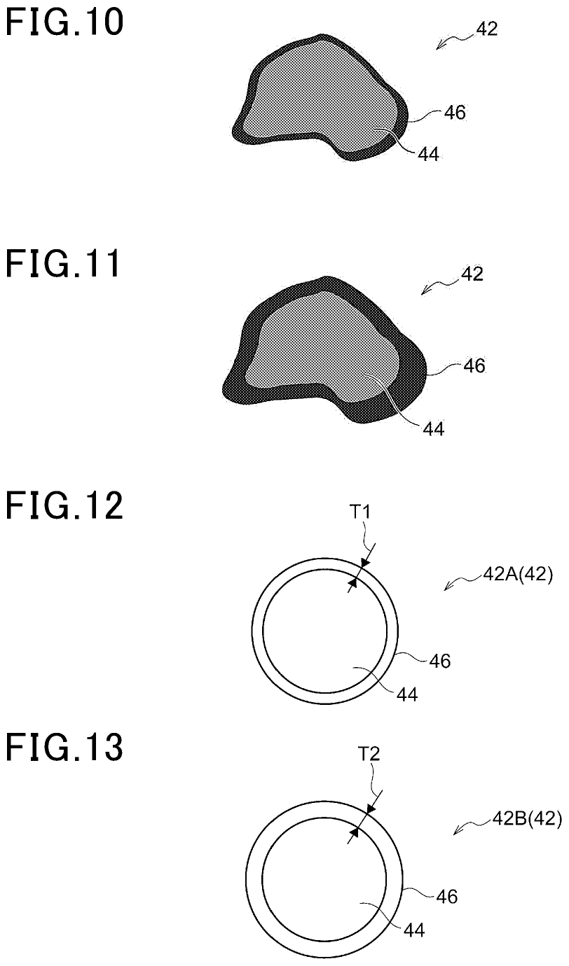

For the magnetic powder 42 which includes the iron powder 44 and the covering portions 46 that cover the iron powder 44, the electrical insulation performance of the magnetic powder 42 can be adjusted by the following method. For example, as shown in FIG. 9, through a first coating step, magnetic powder 42 is formed which includes iron powder 44 and covering portions 46 that cover the iron powder 44. Further, as shown in FIG. 10, by performing a second coating step on the magnetic powder 42 that has undergone the first coating step, the thickness of the covering portions 46 is increased. Furthermore, as shown in FIG. 11, by performing a third coating step on the magnetic powder 42 that has undergone the second coating step, the thickness of the covering portions 46 is further increased. In this way, the electrical insulation properties of the magnetic powder 42 can be improved by increasing the thickness of the covering portions 46. In other words, the electrical insulation performance of the magnetic powder 42 can be adjusted by adjusting the thickness of the covering portions 46.

Moreover, the electrical insulation performance of the magnetic powder 42 can also be adjusted by changing the material forming the covering portions 46. For example, the electrical insulation performance of the magnetic powder 42 can be improved by changing the covering portions 46 from iron-based oxide films to films formed of a phosphate-based material, a borate-based material or a silicon-based material.

As described above, the electrical insulation performance of the magnetic powder 42 can be adjusted by changing at least one of the thickness and material of the covering portions 46 thereof.

In the present embodiment, the stator core 26 is formed of a first-type magnetic powder 42A as shown in FIG. 12 and a second-type magnetic powder 42B as shown in FIG. 13. In other words, the magnetic powder 42 forming the stator core 26 includes a plurality of types of magnetic powders. The first-type magnetic powder 42A and the second-type magnetic powder 42B differ in the thicknesses of the covering portions 46 thereof. Specifically, the thickness T2 of the covering portions 46 of the second-type magnetic powder 42B is greater than the thickness T1 of the covering portions 46 of the first-type magnetic powder 42A. Consequently, the electrical insulation properties of the second-type magnetic powder 42B are higher than the electrical insulation properties of the first-type magnetic powder 42A. In addition, the first-type magnetic powder 42A corresponds to a first-type magnetic powder according to the present disclosure; and the second-type magnetic powder 42B corresponds to a second-type magnetic powder according to the present disclosure.

As shown in FIG. 7, in the stator core 26 (i.e., the powder magnetic core 40) formed of the magnetic powder 42 including the iron powder 44 and the covering portions 46 that cover the iron powder 44, the covering portions 46 of the magnetic powder 42 have electrical insulation properties, thereby making it possible to reduce eddy current I when magnetic flux B flows from each direction into the stator core 26 (i.e., the powder magnetic core 40). As a result, it becomes possible to suppress heat generation of the stator core 26 (i.e., the powder magnetic core 40), thereby reducing the loss of the motor that includes the stator core 26.

Moreover, the stator core 26 according to the present embodiment is formed of the first-type magnetic powder 42A as shown in FIG. 12 and the second-type magnetic powder 42B as shown in FIG. 13. Consequently, in the stator core 26, the electrical insulation properties of any region where the first-type magnetic powder 42A exists are different from the electrical insulation properties of any region where the second-type magnetic powder 42B exists. In other words, it becomes possible to adjust the electrical insulation properties of each part of the stator core 26 according to the present embodiment.

Moreover, the stator core 26, which is formed of the magnetic powder 42 including the iron powder 44 and the covering portions 46 that cover the iron powder 44, can be recycled through the following steps. First, the stator core 26 is removed from a disassembled motor and crushed to obtain magnetic powder 42C as shown in FIG. 14. The thickness T3 of the covering portions 46 of the magnetic powder 42C obtained by crushing the stator core 26 deteriorates due to damage or the like to the covering portions 46 caused by the crushing. That is, the thickness T3 of the covering portions 46 of the magnetic powder 42C obtained by crushing the stator core 26 becomes, at some locations, less than the thickness T1 of the covering portions 46 of the first-type magnetic powder 42A shown in FIG. 12. Therefore, the thickness of the covering portions 46 is increased by performing a coating process on the magnetic powder 42C obtained by crushing the stator core 26. More particularly, the thickness T3 of the covering portions 46 of the magnetic powder 42C is increased to become equal to the thickness T2 of the covering portions 46 of the second-type magnetic powder 42B shown in FIG. 13. That is, the second-type magnetic powder 42B is manufactured from the magnetic powder 42C. In other words, the second-type magnetic powder 42B can also be referred to as a recycled material manufactured using the magnetic powder 42C. Then, a new stator core 26 can be manufactured using the first-type magnetic powder 42A and the second-type magnetic powder 42B that is the recycled material.

In addition, in the present embodiment, the covering portions 46 that cover the iron powder 44 are formed of an inorganic material. Consequently, it becomes unnecessary to perform a step of separating organic matter from the covering portions 46 in the recycling process described above.

### Second Embodiment

Next, the configuration of a stator core 26 according to a second embodiment will be described in detail. It should be noted that members and parts of the stator core 26 according to the second embodiment corresponding to those of the stator core 26 according to the first embodiment are designated by the same reference signs as the corresponding members and parts of the stator core 26 according to the first embodiment; and description of these parts and members will be omitted hereinafter.

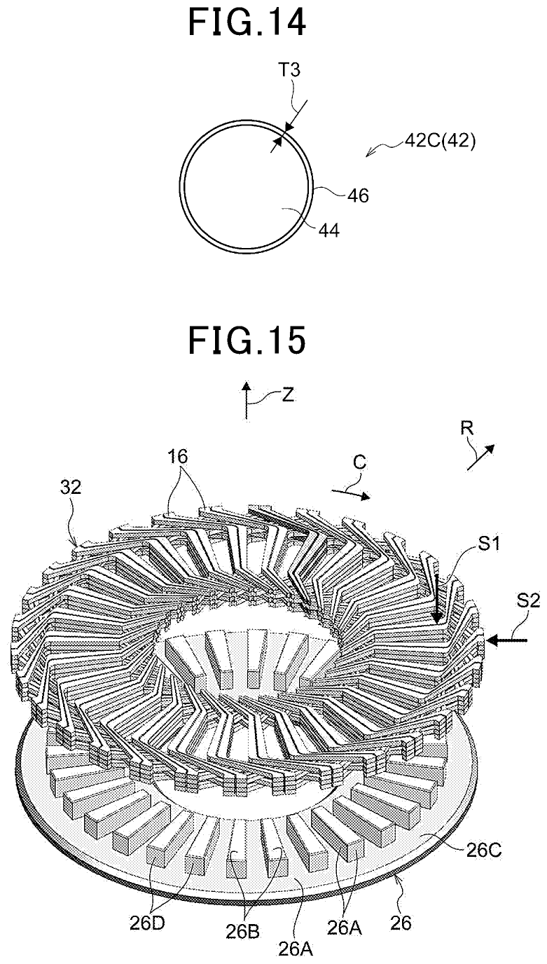

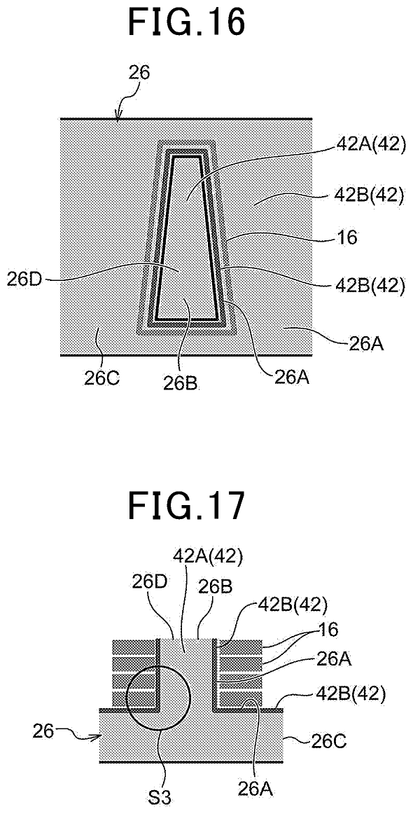

FIGS. 15 to 18 show the stator core 26 according to the second embodiment which has the same configuration as the stator core 26 of the motor 10C described above. As shown in these figures, in the stator core 26 according to the present embodiment, a surface layer 26E is formed, by the second-type magnetic powder 42B, along the coil-facing surface 26A which is the surface of the base plate part 26C on the first side in the axial direction. Moreover, in the stator core 26 according to the present embodiment, surface layers 26E are also formed, by the second-type magnetic powder 42B, along the coil-facing surfaces 26A which are the circumferential end surfaces and radial end surfaces of the tooth parts 26D. On the other hand, in the stator core 26 according to the present embodiment, portions 26F other than the surface layers 26E are formed by the first-type magnetic powder 42A.

In the above-described stator core 26 according to the present embodiment, the surface layers 26E are formed along the coil-facing surfaces 26A by the second-type magnetic powder 42B; and the portions 26F other than the surface layers 26E are formed by the first-type magnetic powder 42A. With the above configuration, it becomes possible to improve the electrical insulation between the coils 16 and the coil-facing surfaces 26A of the stator core 26 as compared with a configuration where the entire stator core 26 is formed by the first-type magnetic powder 42A.

It should be noted that the configuration of the stator core 26 according to the present embodiment can also be applied to the stator cores 26 of the motors 10A and 10B described above. In this case, as shown in FIG. 2, a surface layer 26E may be formed, by the second-type magnetic powder 42B, along the coil-facing surface 26A which is the radially inner surface of the stator core 26; and portions other than the surface layer 26E may be formed by the first-type magnetic powder 42A. Moreover, as shown in FIG. 4, a surface layer 26E may be formed, by the second-type magnetic powder 42B, along the coil-facing surface 26A which is the surface of the stator core 26 on the first side in the axial direction; and portions other than the surface layer 26E may be formed by the first-type magnetic powder 42A.

### Third Embodiment

Next, the configuration of a stator core 26 according to a third embodiment will be described in detail. It should be noted that members and parts of the stator core 26 according to the third embodiment corresponding to those of the stator cores 26 according to the above-described embodiments are designated by the same reference signs as the corresponding members and parts of the stator cores 26 according to the above-described embodiments; and description of these parts and members will be omitted hereinafter.

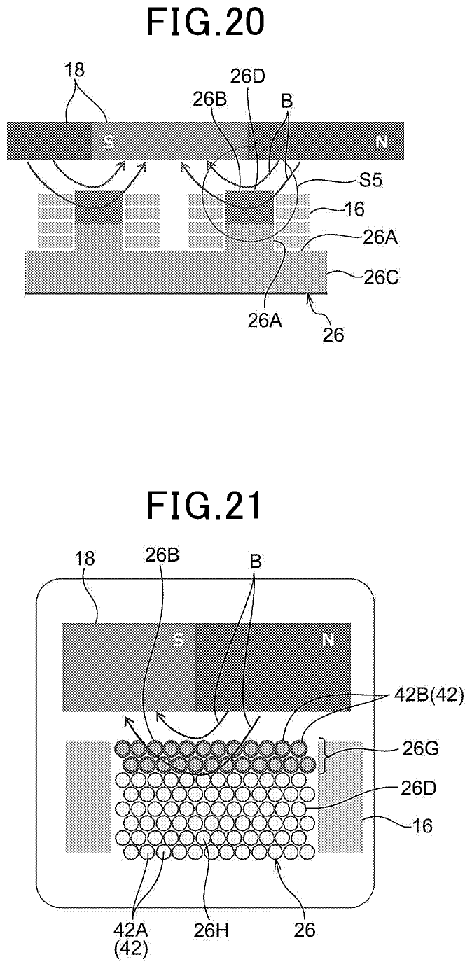

FIGS. 19 to 21 show the stator core 26 according to the third embodiment which has the same configuration as the stator core 26 of the motor 10C described above. As shown in these figures, in the stator core 26 according to the present embodiment, surface layers 26G are formed, by the second-type magnetic powder 42B, along the magnet-facing surfaces 26B which are the end surfaces of the tooth parts 26D on the first side in the axial direction. On the other hand, in the stator core 26 according to the present embodiment, portions 26H other than the surface layers 26G are formed by the first-type magnetic powder 42A.

In the above-described stator core 26 according to the present embodiment, the surface layers 26G are formed along the magnet-facing surfaces 26B by the second-type magnetic powder 42B; the portions 26H other than the surface layers 26G are formed by the first-type magnetic powder 42A. With the above configuration, it becomes possible to reduce loss caused by leakage magnetic flux B of the magnets 18 crossing the tooth parts 26D as compared with the configuration where the entire stator core 26 is formed by the first-type magnetic powder 42A.

It should be noted that the configuration of the stator core 26 according to the present embodiment can also be applied to the stator cores 26 of the motors 10A and 10B described above. In this case, as shown in FIG. 2, a surface layer 26G may be formed, by the second-type magnetic powder 42B, along the magnet-facing surface 26B which is the radially inner surface of the stator core 26; and portions other than the surface layer 26G may be formed by the first-type magnetic powder 42A. Moreover, as shown in FIG. 4, a surface layer 26G may be formed, by the second-type magnetic powder 42B, along the magnet-facing surface 26B which is the surface of the stator core 26 on the first side in the axial direction; and portions other than the surface layer 26G may be formed by the first-type magnetic powder 42A.

### Method of Manufacturing Stator Core 26 According to Second Embodiment

Next, a method of manufacturing the stator core 26 according to the second embodiment will be briefly described.

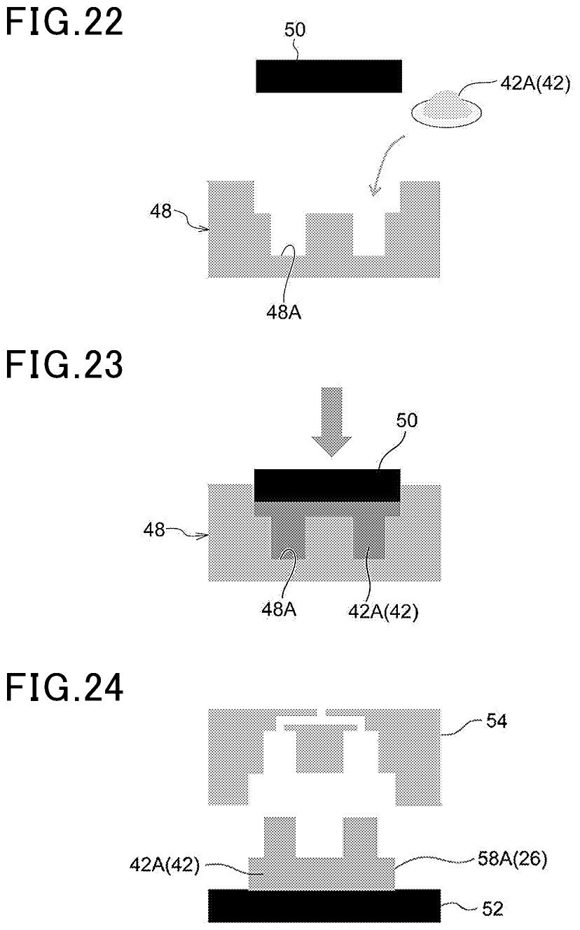

FIGS. 22 to 25 schematically show part of equipment for manufacturing the stator core 26 according to the second embodiment. As shown in these figures, the first-type magnetic powder 42A and the second-type magnetic powder 42B, which are provided for forming the stator core 26 according to the second embodiment, are molded using a first mold 48, a second mold 50, a third mold 52, a fourth mold 54 and an injection apparatus 56.

As shown in FIG. 22, in the first mold 48, there is formed a cavity 48A that is set to a shape and dimensions corresponding to a part 58A (see FIG. 24) of the stator core 26 according to the second embodiment which is formed of the first-type magnetic powder 42A. First, the first-type magnetic powder 42A is placed into the cavity 48A.

Next, as shown in FIG. 23, the first-type magnetic powder 42A placed into the cavity 48A of the first mold 48 is compressed between the first mold 48 and the second mold 50.

Through the steps up to this point, the part 58A of the stator core 26 according to the second embodiment which is formed of the first-type magnetic powder 42A is obtained. Then, the part 58A of the stator core 26 according to the second embodiment which is formed of the first-type magnetic powder 42A is placed on the third mold 52.

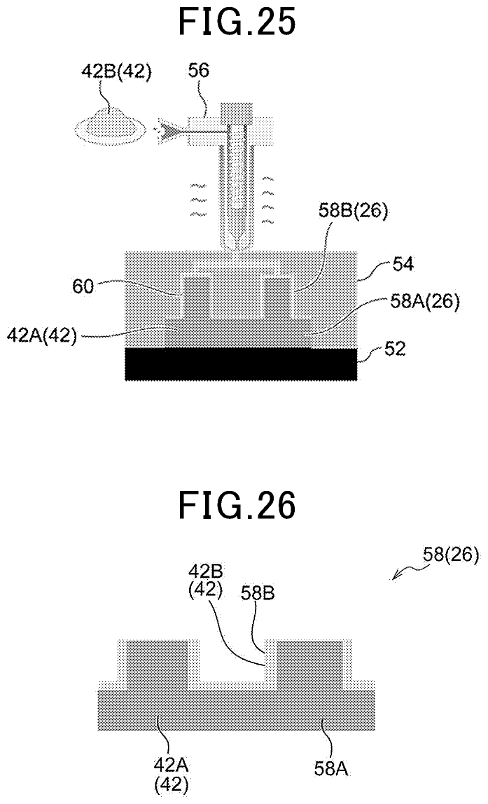

Next, as shown in FIGS. 24 and 25, the part 58A of the stator core 26 according to the second embodiment which is formed of the first-type magnetic powder 42A is set between the third mold 52 and the fourth mold 54. Between the part 58A of the stator core 26 according to the second embodiment which is formed of the first-type magnetic powder 42A and the fourth mold 54, there is formed a gap 60 having a shape and dimensions corresponding to parts 58B (see FIG. 26) of the stator core 26 according to the second embodiment which are formed of the second-type magnetic powder 42B. Next, the second-type magnetic powder 42B is injected, by the injection apparatus 56 that is connected with the fourth mold 54, into the gap 60.

Next, as shown in FIGS. 25 and 26, a molded product 58, into which the part 58A of the stator core 26 according to the second embodiment which is formed of the first-type magnetic powder 42A and the parts 58B of the stator core 26 according to the second embodiment which are formed of the second-type magnetic powder 42B are integrated, is removed from between the third mold 52 and the fourth mold 54. Then, as a heat treatment, annealing is performed on the molded product 58. Through the above steps, the stator core 26 according to the second embodiment is manufactured.

### Method of Manufacturing Stator Core 26 According to Third Embodiment

Next, a method of manufacturing the stator core 26 according to the third embodiment will be briefly described.

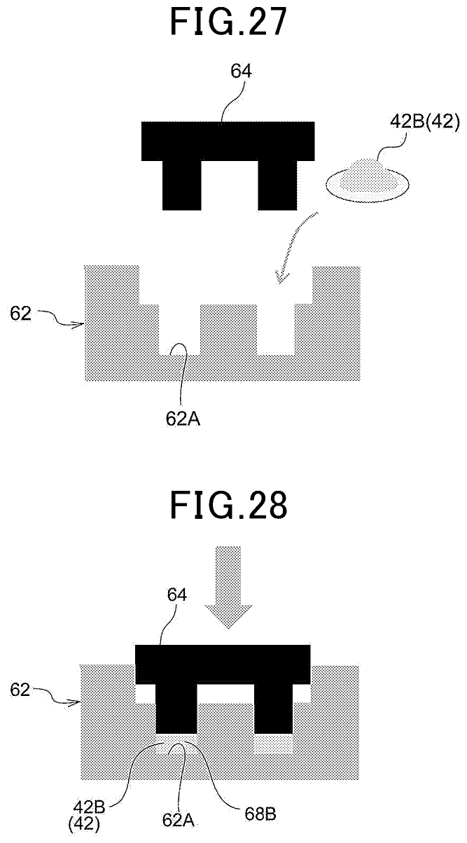

FIGS. 27 to 30 schematically show part of equipment for manufacturing the stator core 26 according to the third embodiment. As shown in these figures, the first-type magnetic powder 42A and the second-type magnetic powder 42B, which are provided for forming the stator core 26 according to the third embodiment, are molded using a first mold 62, a second mold 64 and a third mold 66.

As shown in FIG. 27, in the first mold 62, there is formed a cavity 62A that is set to a shape and dimensions corresponding to a molded product 68 (see FIG. 31) into which a part 68A of the stator core 26 according to the third embodiment which is formed of the first-type magnetic powder 42A and parts 68B of the stator core 26 according to the third embodiment which are formed of the second-type magnetic powder 42B are integrated. First, the second-type magnetic powder 42B is placed into the cavity 62A.

Next, as shown in FIG. 28, the second-type magnetic powder 42B placed into the cavity 62A of the first mold 62 is compressed between the first mold 62 and the second mold 64. Consequently, the parts 68B of the stator core 26 according to the third embodiment which are formed of the second-type magnetic powder 42B are obtained.

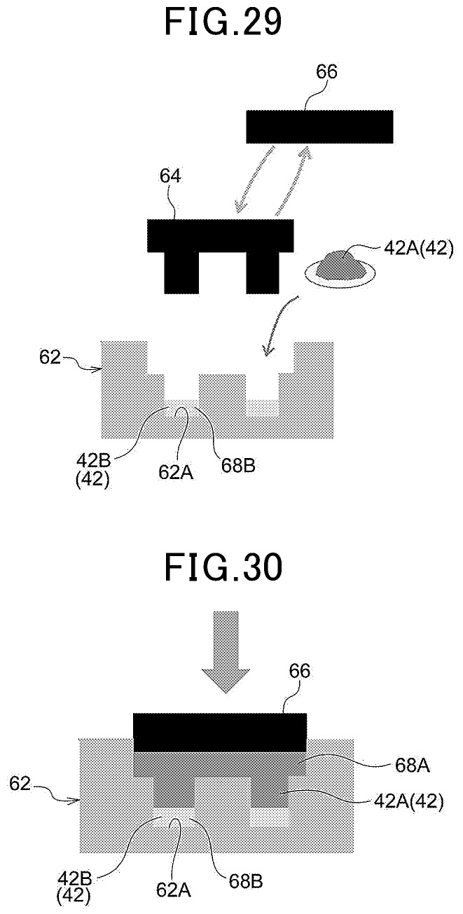

Next, as shown in FIG. 29, the first-type magnetic powder 42A is placed into the cavity 62A formed in the first mold 62.

Next, as shown in FIG. 30, the first-type magnetic powder 42A placed into the first mold 62 is compressed, together with the second-type magnetic powder 42B (i.e., the parts 68B of the stator core 26 according to the third embodiment which are formed of the second-type magnetic powder 42B), between the first mold 62 and the third mold 66.

Next, as shown in FIGS. 30 and 31, the molded product 68, into which the part 68A of the stator core 26 according to the third embodiment which is formed of the first-type magnetic powder 42A and the parts 68B of the stator core 26 according to the third embodiment which are formed of the second-type magnetic powder 42B are integrated, is removed from between the first mold 62 and the third mold 66. Then, as a heat treatment, annealing is performed on the molded product 68. Through the above steps, the stator core 26 according to the third embodiment is manufactured.

### Management of Performance of Part Formed of Recycled Material

As described above, the stator cores 26 according to the above-described embodiments can be manufactured using the first-type magnetic powder 42A and the second-type magnetic powder 42B that is a recycled material. In this case, management of the performance of a part formed of the second-type magnetic powder 42B is important. Hereinafter, configurations and methods for managing the performance of a part formed of the second-type magnetic powder 42B, which is a recycled material, will be described.

### Stator Cores 26 According to Fourth to Sixth Embodiments

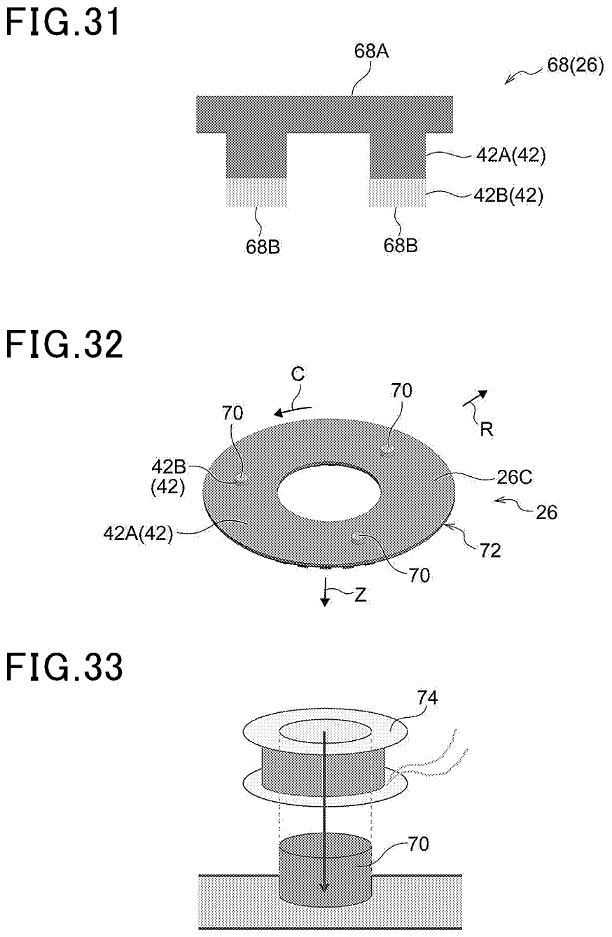

With reference to FIG. 32, the configuration of a stator core 26 according to a fourth embodiment will be described in detail. It should be noted that members and parts of the stator core 26 according to the fourth embodiment corresponding to those of the stator cores 26 according to the above-described embodiments are designated by the same reference signs as the corresponding members and parts of the stator cores 26 according to the above-described embodiments; and description of these parts and members will be omitted hereinafter.

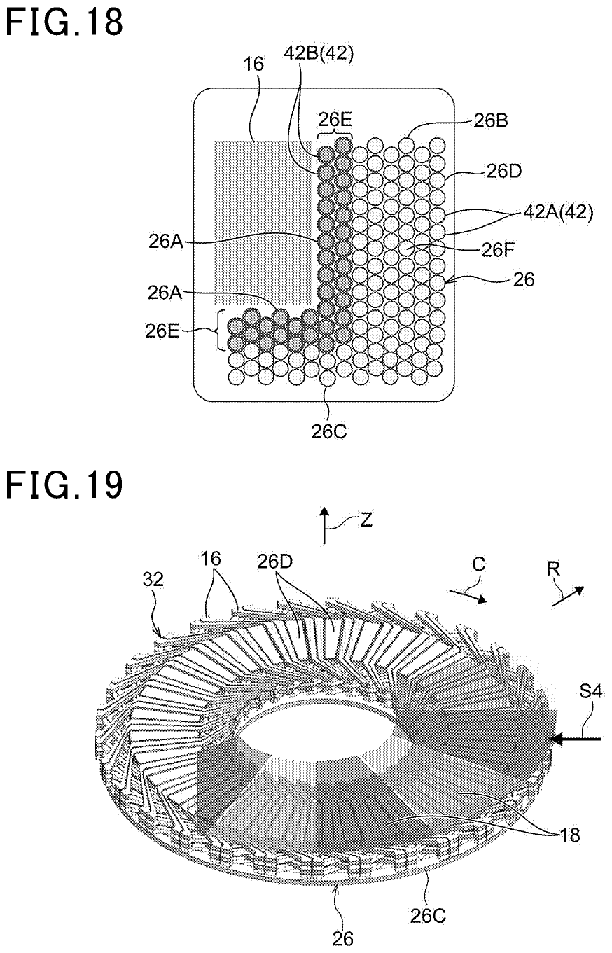

As shown in FIG. 32, the configuration of the stator core 26 according to the fourth embodiment is identical to the configuration of the stator core 26 according to the second embodiment (see FIG. 18) or the configuration of the stator core 26 according to the third embodiment (see FIG. 21), except that inspection parts 70 are provided in the stator core 26 according to the fourth embodiment. It should be noted that in the following explanation, a part of the stator core 26 according to the fourth embodiment which corresponds to the stator core 26 according to the second embodiment or the stator core 26 according to the third embodiment will be referred to as a stator core main body 72.

The inspection parts 70 are provided at different positions from the coil-facing surfaces 26A (see, for example, FIG. 18) and the magnet-facing surfaces 26B (see, for example, FIG. 18). Moreover, the inspection parts 70 are formed of the same second-type magnetic powder 42B as that used for forming the stator core main body 72. Specifically, in the stator core 26 according to the fourth embodiment, there are provided a plurality (e.g., three) of inspection parts 70 that protrude, from the surface of the base plate part 26C on the second side in the axial direction, toward the second side in the axial direction. Each of the inspection parts 70 is formed in a cylindrical shape. Moreover, the inspection parts 70 are arranged on a radially central portion of the base plate part 26C and arranged at equal intervals in the circumferential direction.

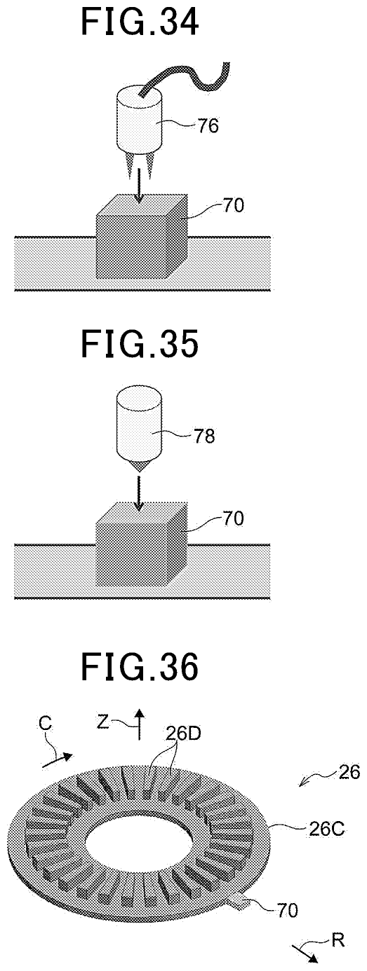

In the stator core 26 having the inspection parts 70, the magnetic permeability of those parts of the stator core 26 which are formed of the second-type magnetic powder 42B can be inspected by inserting one of the inspection parts 70 into an inner peripheral space of a search coil 74 as shown in FIG. 33. Moreover, the electrical resistivity of those parts of the stator core 26 which are formed of the second-type magnetic powder 42B can be inspected by pressing an electrical-resistivity measurement terminal 76 against one of the inspection parts 70 as shown in FIG. 34. Furthermore, the hardness of those parts of the stator core 26 which are formed of the second-type magnetic powder 42B can be inspected by pressing a hardness measurement terminal 78 against one of the inspection parts 70 as shown in FIG. 35. It should be noted that the inspection parts 70 shown in FIGS. 34 and 35 are each depicted as having a rectangular block shape.

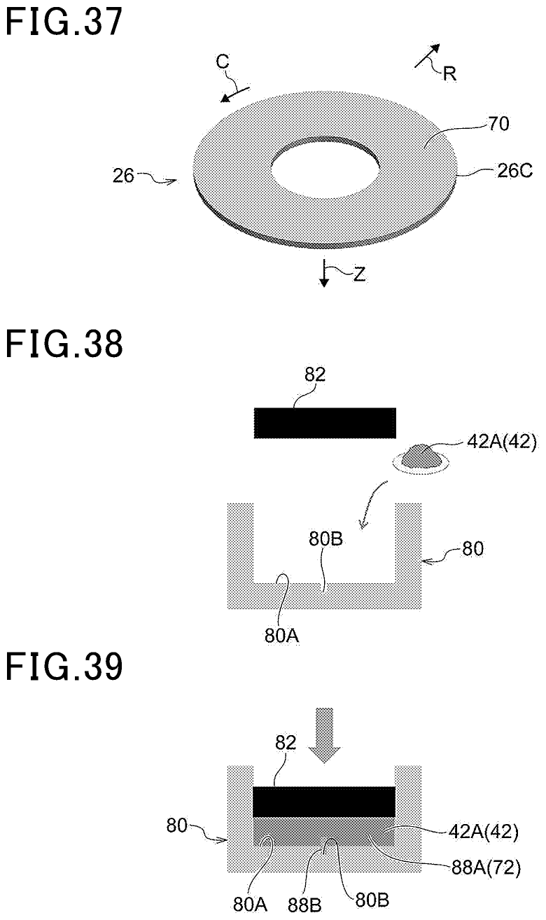

In addition, the positions of the inspection parts 70 are not limited to those described above. For example, as in a stator core 26 according to a fifth embodiment shown in FIG. 36, an inspection part 70 may be provided in such a manner as to protrude radially outward from a radially outer end of the base plate part 26C. Otherwise, as in a stator core 26 according to a sixth embodiment shown in FIG. 37, an inspection part 70 may be provided as a surface layer of the entire surface of the base plate part 26C on the second side in the axial direction.

### Method of Forming Inspection Part 70

Next, a method of forming an inspection part 70 will be briefly described.

FIGS. 38 to 41 schematically show part of equipment for forming a stator core main body 72 and an inspection part 70. As shown in these figures, the first-type magnetic powder 42A provided for forming the stator core main body 72 and the second-type magnetic powder 42B provided for forming the inspection part 70 are molded using a first mold 80, a second mold 82, a third mold 84 and a fourth mold 86.

As shown in FIG. 38, in the first mold 80, there is formed a cavity 80A that is set to a shape and dimensions corresponding to a part 88A (see FIG. 42) of the stator core main body 72 which is formed of the first-type magnetic powder 42A. First, the first-type magnetic powder 42A is placed into the cavity 80A.

Next, as shown in FIG. 39, the first-type magnetic powder 42A placed into the cavity 80A of the first mold 80 is compressed between the first mold 80 and the second mold 82. Consequently, the part 88A of the stator core main body 72 which is formed of the first-type magnetic powder 42A is obtained. Moreover, in a bottom of the first mold 80, there is formed a hole 80B. Consequently, a protrusion 88B is formed on an area of the part 88A to which the inspection part 70 is to be joined.

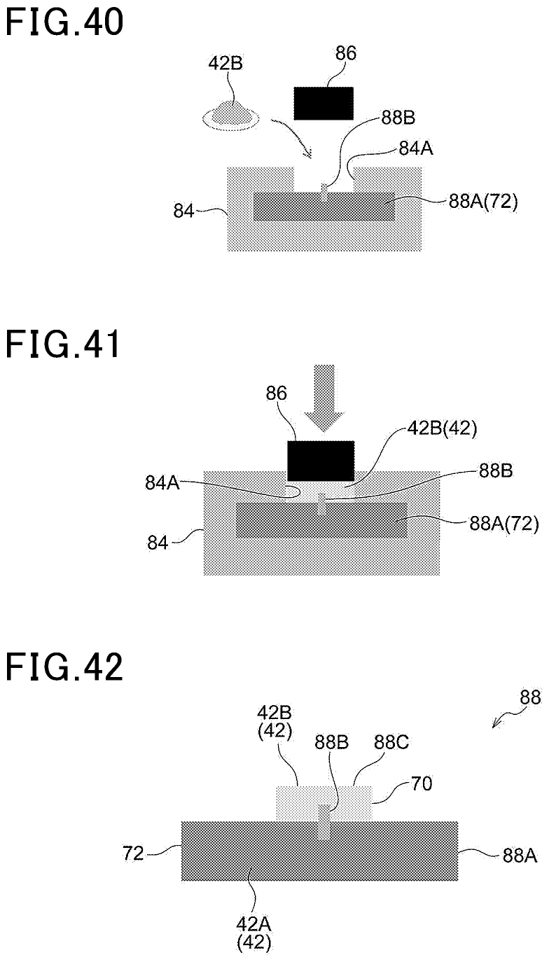

Next, as shown in FIG. 40, the molded part 88A is set in the third mold 84. In the third mold 84, there is formed an exposure hole 84A through which the area of the part 88A to which the inspection part 70 is to be joined is exposed. Then, the second-type magnetic powder 42B is placed into the exposure hole 84A.

Next, as shown in FIG. 41, the second-type magnetic powder 42B placed into the exposure hole 84A is compressed, together with the part 88A and the protrusion 88B, between the third mold 84 and the fourth mold 86.

Next, as shown in FIGS. 41 and 42, a molded product 88, into which the part 88A of the stator core main body 72 which is formed of the first-type magnetic powder 42A and a part 88C constituting the inspection part 70 are integrated, is removed from between the third mold 84 and the fourth mold 86. It should be noted that portions of the stator core main body 72 which are formed of the second-type magnetic powder 42B are molded in another step. Then, as a heat treatment, annealing is performed on the molded product 88. Through the above steps, the stator core 26 having the inspection part 70 is manufactured.

In the stator cores 26 according to the above-described embodiments, the covering portions 46 that cover the iron powder 44 are formed of an inorganic material; however, the present disclosure is not limited thereto. For example, the material of the covering portions 46 that cover the iron powder 44 may include an organic material. Moreover, the stator cores 26 may include a third-type magnetic powder. In this case, the third-type magnetic powder does not correspond to the other types of magnetic powders. Furthermore, the third-type magnetic powder may or may not have higher electrical insulation properties than the first-type magnetic powder 42A and the second-type magnetic powder 42B. In addition, the thickness of the covering portions 46 of the third-type magnetic powder may be set to be greater than the thickness of the covering portions 46 of the first-type magnetic powder 42A and the thickness of the covering portions 46 of the second-type magnetic powder 42B.

In the stator cores 26 according to the above-described embodiments, the base material of the magnetic powder 42 is the iron powder 44; however, the present disclosure is not limited thereto. For example, the base material of the magnetic powder 42 may be a mixture of an iron-based material and another material.

The configurations of the stator cores 26 (i.e., the powder magnetic cores 40) according to the above-described embodiments can also be applied to field cores.

While the above embodiments of the present disclosure have been described, it will be understood by those skilled in the art that the present disclosure is not limited to the above-described embodiments, but may be carried out through various modifications to the above-described embodiments without departing from the spirit of the present disclosure. Moreover, all or some of the configurations of the stator cores 26 according to the above-described embodiments may be combined with each other. Furthermore, the configurations of the motors 10 according to the above-described embodiments can also be applied to electric generators. Furthermore, the configurations according to the present disclosure can also be applied to rotors which include a coil assembly 32.

### NOTES

### First Note

A core (26) for a rotating electric machine, the core being formed of magnetic powder (42), the magnetic powder having:

a powdery base material (44) constituted of an iron-based material; and

covering portions (46) having higher electrical insulation properties than the base material and covering the base material,

wherein

the magnetic powder comprises a plurality of types of magnetic powders (42A, 42B) differing in at least one of thickness and material of the covering portions.

### Second Note

The core according to the first note, wherein the covering portions are formed of an inorganic material.

### Third Note

The core according to the first note, wherein the magnetic powder forming the core comprises:

a first-type magnetic powder (42A); and

a second-type magnetic powder (42B) whose covering portions have higher electrical insulation properties than the covering portions of the first-type magnetic powder.

### Fourth Note

The core according to the third note, wherein

the core is configured to be used in a stator of a rotating electric machine, the stator having a coil (16) wound thereto,

the core has a coil-facing surface (26A) to be arranged so as to face the coil, and

the second-type magnetic powder is arranged along the coil-facing surface.

### Fifth Note

The core according to the third or fourth note, wherein the thickness (T2) of the covering portions of the second-type magnetic powder is greater than the thickness (T1) of the covering portions of the first-type magnetic powder.

### Sixth Note

The core according to the fifth note, wherein

the core is configured to be used in a stator of a rotating electric machine,

the core has a magnet-facing surface (26B) to be arranged so as to face a magnet (18) of the rotating electric machine, and

the second-type magnetic powder is arranged along the magnet-facing surface.

### Seventh Note

The core according to the fifth note, wherein

the core has a coil-facing surface (26A) to be arranged so as to face a coil (16) of a rotating electric machine, and a magnet-facing surface (26B) to be arranged so as to face a magnet (18) of the rotating electric machine, and

in the core, there is provided an inspection part (70) that is formed of the second-type magnetic powder.

### Eighth Note

An armature (14) comprising:

a core (26) formed of magnetic powder (42), the magnetic powder having a powdery base material (44) constituted of an iron-based material and covering portions (46) having higher electrical insulation properties than the base material and covering the base material, wherein the magnetic powder comprises a plurality of types of magnetic powders (42A, 42B) differing in at least one of thickness and material of the covering portions; and

a coil (16) arranged along the core and configured to generate a magnetic field when supplied with electric power.

### Ninth Note

A rotating electric machine (10A, 10B, 10C) comprising:

a stator (14); and

a rotor (12),

wherein

one of the stator and the rotor includes an armature (14), the armature comprising:
a core (26) formed of magnetic powder (42), the magnetic powder having a powdery base material (44) constituted of an iron-based material and covering portions (46) having higher electrical insulation properties than the base material and covering the base material, wherein the magnetic powder comprises a plurality of types of magnetic powders (42A, 42B) differing in at least one of thickness and material of the covering portions; and
a coil (16) arranged along the core and configured to generate a magnetic field when supplied with electric power, and

the other of the stator and the rotor has a magnet (18) arranged so as to face the coil and the core.

What is claimed is:

1. A core for a rotating electric machine, the core being formed of magnetic powder, the magnetic powder having:
a powdery base material constituted of an iron-based material; and
covering portions having higher electrical insulation properties than the base material and covering the base material,
wherein
the magnetic powder comprises a plurality of types of magnetic powders differing in at least one of thickness and material of the covering portions.

2. The core as set forth in claim 1, wherein the covering portions are formed of an inorganic material.

3. The core as set forth in claim 1, wherein the magnetic powder forming the core comprises:
a first-type magnetic powder; and
a second-type magnetic powder whose covering portions have higher electrical insulation properties than the covering portions of the first-type magnetic powder.

4. The core as set forth in claim 3, wherein
the core is configured to be used in a stator of a rotating electric machine, the stator having a coil wound thereto,
the core has a coil-facing surface to be arranged so as to face the coil, and
the second-type magnetic powder is arranged along the coil-facing surface.

5. The core as set forth in claim 3, wherein the thickness of the covering portions of the second-type magnetic powder is greater than the thickness of the covering portions of the first-type magnetic powder.

6. The core as set forth in claim 5, wherein
the core is configured to be used in a stator of a rotating electric machine,
the core has a magnet-facing surface to be arranged so as to face a magnet of the rotating electric machine, and
the second-type magnetic powder is arranged along the magnet-facing surface.

7. The core as set forth in claim 5, wherein
the core has a coil-facing surface to be arranged so as to face a coil of a rotating electric machine, and a magnet-facing surface to be arranged so as to face a magnet of the rotating electric machine, and
in the core, there is provided an inspection part that is formed of the second-type magnetic powder.

8. An armature comprising:
a core formed of magnetic powder, the magnetic powder having a powdery base material constituted of an iron-based material and covering portions having higher electrical insulation properties than the base material and covering the base material, wherein the magnetic powder comprises a plurality of types of magnetic powders differing in at least one of thickness and material of the covering portions; and
a coil arranged along the core and configured to generate a magnetic field when supplied with electric power.

9. A rotating electric machine comprising:
a stator; and
a rotor,
wherein
one of the stator and the rotor includes an armature, the armature comprising:
a core formed of magnetic powder, the magnetic powder having a powdery base material constituted of an iron-based material and covering portions having higher electrical insulation properties than the base material and covering the base material, wherein the magnetic powder comprises a plurality of types of magnetic powders differing in at least one of thickness and material of the covering portions; and
a coil arranged along the core and configured to generate a magnetic field when supplied with electric power, and
the other of the stator and the rotor has a magnet arranged so as to face the coil and the core.
